(19) United States
(12) Patent Application Publication
(10) Pub. No.: US 2016/0147325 A1
(43) Pub. Date: May 26, 2016

(54) FAN-OUT TRACE STRUCTURE OF TOUCH MODULE OF TOUCH DEVICE

(71) Applicants: NTERFACE OPTOELECTRONIC (SHENZHEN) CO., LTD., Shenzhen (CN); GENERAL INTERFACE SOLUTION LIMITED, Miaoli County (TW)

(72) Inventors: CHIA-CHUN TAI, Hsinchu (TW); YING-CHIEH CHIANG, (US); TZU-HSIANG LIN, (US); YEN-HENG HUANG, Hsinchu (TW)

(21) Appl. No.: 14/561,230

(22) Filed: Dec. 5, 2014

(30) Foreign Application Priority Data
Nov. 26, 2014 (CN) 201410703444.1

(51) Int. Cl. G06F 3/041

(52) U.S. Cl. CPC G06F 3/041; G06F 2203/04103

(57) ABSTRACT

A touch module of a touch device defines a touch area and a trace area surrounding the touch area. The touch module includes a substrate, a number of first sensor electrodes, a number of second sensor electrodes, and a number of conductive traces. The number of first sensor electrodes and the number of second sensor electrodes are arranged in a first region on the substrate corresponding to the touch area. The number of conductive traces are arranged in a second region on the substrate corresponding to the trace area. At least one of the conductive traces includes at least two conductive layers.

### CROSS-REFERENCE TO RELATED APPLICATIONS

This application claims priority to Chinese Patent Application No. 201410703444.1 filed on Nov. 26, 2014 in the Chinese Intellectual Property Office, the contents of which are incorporated by reference herein.

### FIELD

Embodiments of the present disclosure generally relate to a touch device having a touch module, and more particularly, to fan-out traces in a border area of the touch module.

### BACKGROUND

Generally, touch modules can be categorized into resistive touch modules, capacitive touch modules, optical touch modules, acoustic-wave touch modules, electromagnetic touch modules, and the like. Capacitive touch modules have been extensively applied to various touch devices, such as smart phones and tablet computers, due to fast response speed, favorable reliability, and durability. A conventional touch module includes a substrate, a touch-sensing circuit, and fan-out traces. The substrate has a touch-sensing region and a peripheral region surrounding the touch-sensing region, so that the touch-sensing circuit is located on the touch-sensing region of the substrate, and the fan-out traces are located on the peripheral region of the substrate.

### BRIEF DESCRIPTION OF THE DRAWINGS

Implementations of the present technology will now be described, by way of example only, with reference to the attached figures.

FIG. 1 is an isometric view of a touch device.

FIG. 2 shows a cross-sectional view of the touch device taken along line II-II of FIG. 1.

FIG. 3 shows a schematic view of a touch module of the touch device of FIG. 2.

FIG. 4 is a cross-sectional view of the touch module of FIG. 3 taken along line VI-VI according to a first embodiment.

FIG. 5 is an enlarged view of a region V of FIG. 3.

FIG. 6 shows a schematic view of a first conductive line and a second conductive line of FIG. 4 which are partially overlapped with each other.

FIG. 7 shows a schematic view of the first conductive line and the second conductive line of FIG. 4 which are staggered relative to each other.

FIG. 8 is a cross-sectional view of the touch module of FIG. 3 taken along line VI-VI according to a second embodiment.

FIG. 9 is a cross-sectional view of the touch module of FIG. 3 taken along line VI-VI according to a third embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The connection can be such that the objects are permanently connected or releasably connected.

The present disclosure is described in relation to a scanning method for a touch module of a touch device.

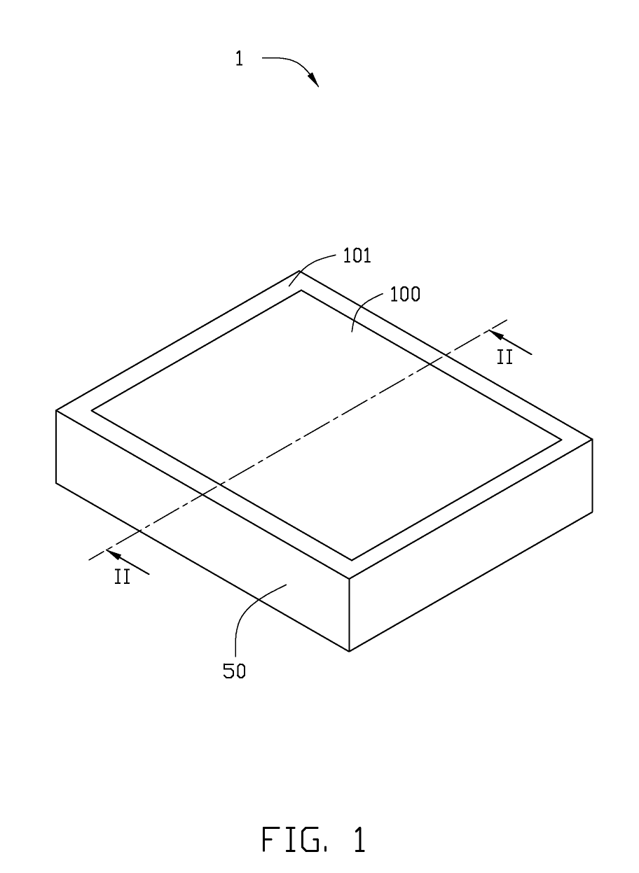

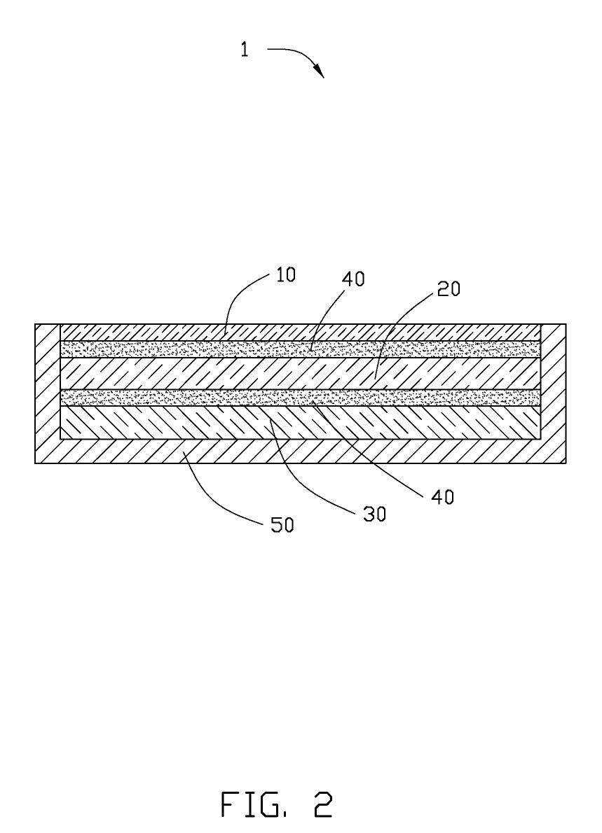

Referring to FIG. 1 and FIG. 2, FIG. 1 illustrates an isometric view of a touch device 1, and FIG. 2 is a cross-sectional view of the touch device 1 taken along line II-II of FIG. 1. The touch device 1 includes a cover glass 10, a touch module 20, a display module 30, and a housing 50. The touch device 1 defines a display area 100 and a border area 101 surrounding the display area 100. The border area 101 is also known as a trace area which is located between the display area and the housing 50. The touch module 20 and the display module 30 can be received in a receiving space defined by the cover glass 10 and the housing 50. In at least one embodiment, the cover glass 10 is also known as a cover lens, which includes a transparent portion corresponding to the display area 100 and a non-transparent portion corresponding to the border area 101.

The cover glass 10 and the touch module 20 are stacked on the display module 30. The touch module 20 can be adhered between the cover glass 10 and the display module 30 by using optical adhesive. In at least one embodiment, the optical adhesive can be optical clear adhesive (OCA) or optical clear resin (OCR) having a high light transmittance.

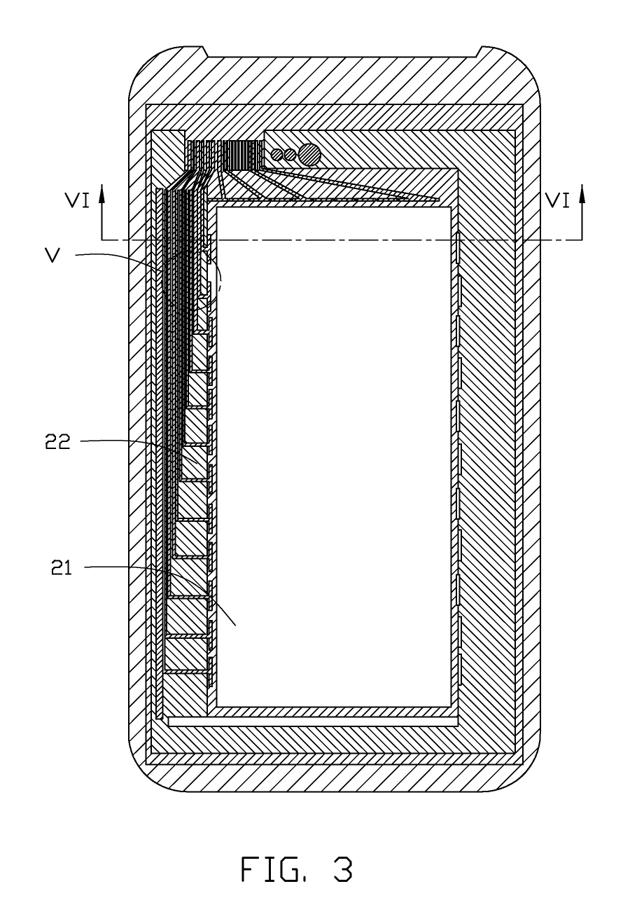

Referring to FIG. 3, the touch module 20 includes a touch area 21 and a trace area 22 surrounding the touch area 21. The trace area 22 is used for arrangement of various conductive traces of the touch module 20. The trace area 22 corresponds to the border area 101 of the touch device 1. A dimension of the trace area 22 is a very important factor in determining a dimension of the border area 101 of the touch device 100. In this embodiment, the conductive traces arranged in the trace area 22 are metal traces. The metal traces can be straight traces or bending traces.

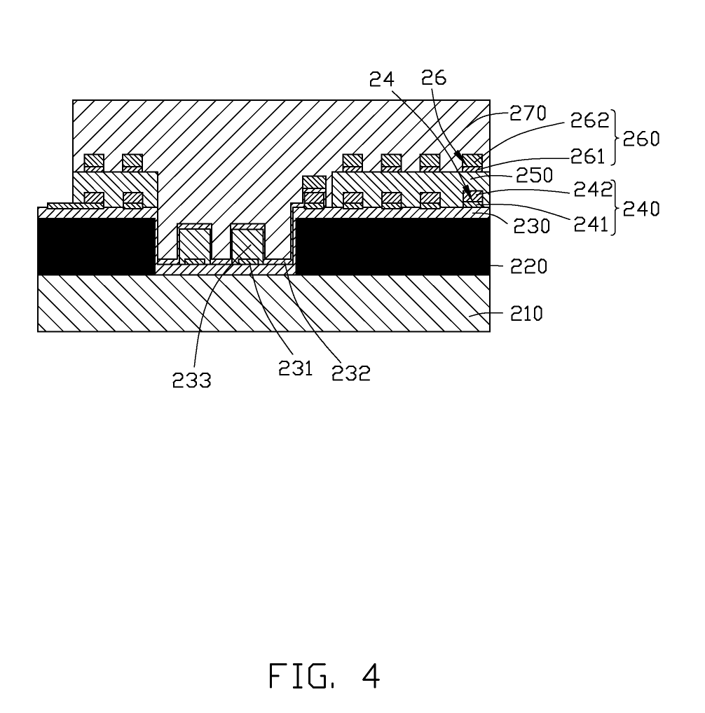

Referring to FIG. 4, FIG. 4 is a cross-sectional view of the touch module 20 taken along line VI-VI of FIG. 3 according to a first embodiment. In the first embodiment, the touch module 20 includes a substrate 210. The substrate 210 can be a glass substrate, a transparent resin substrate, or a transparent thin film substrate, for example. A shielding layer 220 is coated on a surface of the substrate 210. The shielding layer 220 is located at a position on the surface of the substrate 210 corresponding to the trace area 22.

The shielding layer 220 can be made of black resin or other light shielding materials. In at least one embodiment, light shielding materials can be coated on the substrate 210 by a spin coating method or a scraping coating method to form a coating layer. A thickness of the coating layer is about 0.3 μm to about 5 μm. Then, the coating layer is processed by a pre-baking process, an exposing process, and a developing process, to form the shielding layer 220.

The touch module 20 further includes a first insulation layer 230 covered on the substrate 210 and the shielding layer 220. In this embodiment, the first insulation layer 230 is divided into a first region corresponding to the touch area 21, and a second region corresponding to the trace area 22. A plurality of first sensor electrodes 231 and a plurality of second sensor electrodes 232 are arranged in the first region of the first insulation layer 230. The first sensor electrodes 231 and the second sensor electrodes 232 are made of conductive materials. In at least one embodiment, the first sensor electrodes 231 and the second sensor electrodes 232 are made of transparent conductive materials, such as indium tin oxide (ITO). The first electrodes 231 are insulated from the second sensor electrodes 232 via a first protection layer 233. The first protection layer 233 can be made of insulating materials such as resin materials or photo resist materials.

A first trace layer 24 is formed in the second region of the first insulation layer 230 corresponding to the trace area 22 of the touch module 20. The first trace layer 24 includes a plurality of first conductive traces 240 coupled to the first sensor electrodes 231 or the second sensor electrodes 232. The first conductive traces 240 are separated from each other. In at least one embodiment, at least one first conductive trace 240 includes a first conductive layer 241 and a second conductive layer 242 covering the first conductive layer 241. The first conductive layer 241 and the second conductive layer 242 can be made of the same conductive materials or different conductive materials.

In one embodiment, each of the first conductive traces 240 includes the first conductive layer 241 and the second conductive layer 242, and the first conductive layer 241 and the second conductive layer 242 are made of different conductive materials. In the embodiment, the first conductive traces 240 are coupled to the first sensor electrodes 231, and the first conductive layer 241 and the first sensor electrode 231 are made of the same materials in a same mask etching process. The second conductive layer 242 is made of metal materials or alloy materials and electrically coupled with the first conductive layer 241.

A second insulation layer 250 is formed on the first trace layer 24. The second insulation layer 250 can be made of the same materials as the first protection layer 233 in a same manufacturing process. A second trace layer 26 is formed on the second insulation layer 250. The second trace layer 26 includes a plurality of second conductive traces 260. The second conductive traces 260 are separated from each other. In at least one embodiment, at least one second conductive trace 260 includes a third conductive layer 261 and a fourth conductive layer 262 covering the third conductive layer 261. The third conductive layer 261 and the fourth conductive layer 262 can be made of the same conductive materials or different conductive materials.

In one embodiment, each of the second conductive traces 260 includes the third conductive layer 261 and the fourth conductive layer 262, and the third conductive layer 261 and the fourth conductive layer 262 are made of different conductive materials. In the embodiment, the second conductive trace 260 is coupled to the second sensor electrode 232, and the third conductive layer 261 and the second electrode 232 are made of the same materials in a same mask etching process. The fourth conductive layer 262 is made of metal materials or alloy materials and electrically coupled with the third conductive layer 261. In addition, a second protection layer 270 is formed on the second trace layer 26 and covers the second conductive traces 260. The second protection layer 270 can be made of organic materials or inorganic materials.

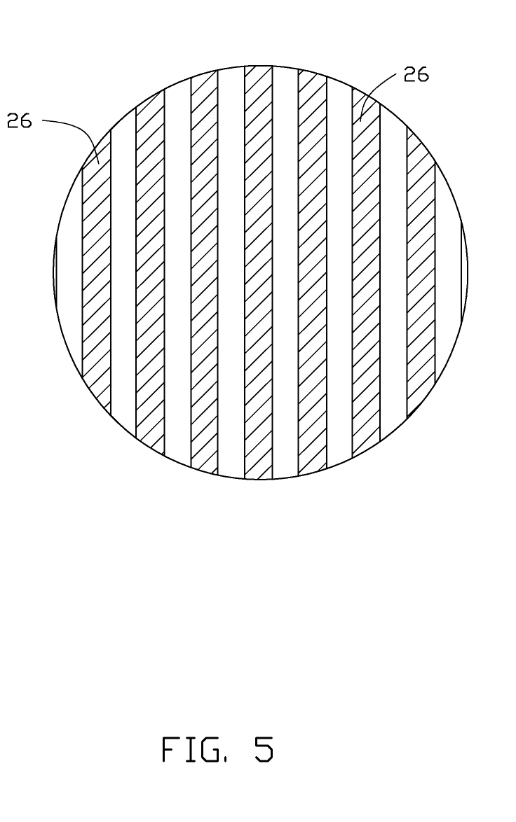

Referring to FIG. 5, FIG. 5 is an enlarged view of the second conductive traces 260 in a region V of FIG. 3. In at least one embodiment, the second conductive traces 260 are overlapped on the first conductive traces 240 in a direction perpendicular to the substrate 210. In one embodiment, a distance between two adjacent first conductive traces 240 is substantially equal to a distance between two adjacent second conductive traces 260. Thus, the trace area 22 of the touch module 20 can have a width 50% smaller than the traditional touch module having a single trace layer, thereby allowing the touch module 20 to have a narrower border. Further, a distance between the two adjacent first conductive traces 240 is equal to a trace width of the first conductive trace 240, and a distance between the two adjacent second conductive traces 260 is equal to a trace width of the second conductive trace 260. For example, the distance between the two adjacent first conductive traces 240 and the distance between the two adjacent second conductive traces 260 both are 30 μm. A total number of the first conductive traces 240 on the first trace layer 24 is equal to a total number of the second conductive traces 260 on the second trace layer 26.

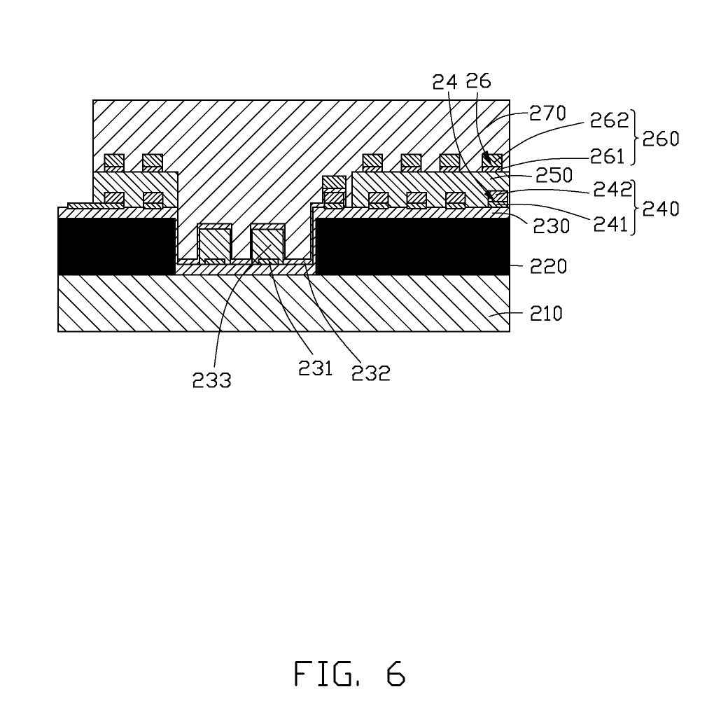

Referring to FIG. 6, in other embodiments, the first conductive traces 240 and the second conductive traces 260 can be partially overlapped. Thus, a portion of the second conductive trace 260 projected on the first trace layer 24 is located between two adjacent first conductive traces 240.

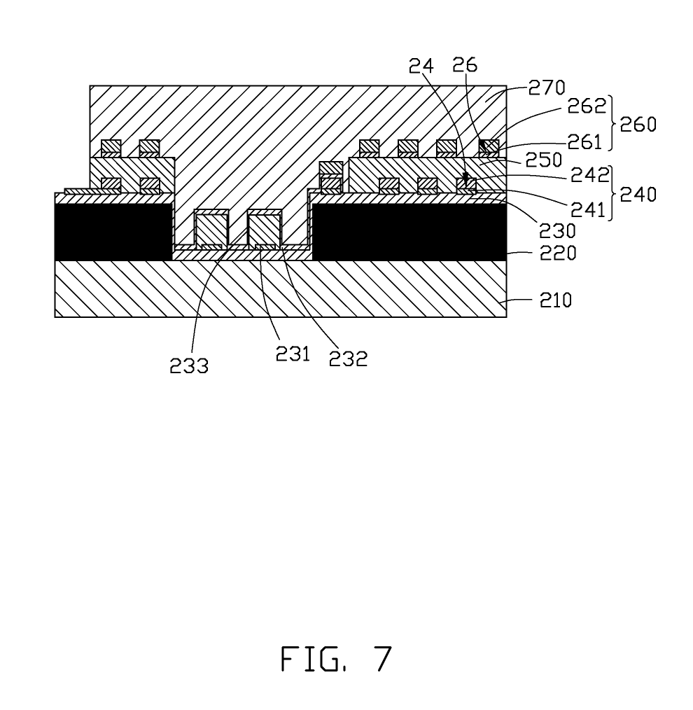

Referring to FIG. 7, in other embodiments, positions of the first conductive traces 240 and the second conductive traces 260 can be staggered relative to each other. That is, the second conductive trace 260 projected on the first trace layer 24 is located in a space between two adjacent first conductive traces 240.

It should be understood that, in other embodiments, the first conductive traces 240 and the second conductive traces 260 can also include more than two conductive layers. Further, the multiple trace layer structure of the first conductive traces 240 and the second conductive traces 260 can also be applied to the traditional touch module which has a single trace layer structure.

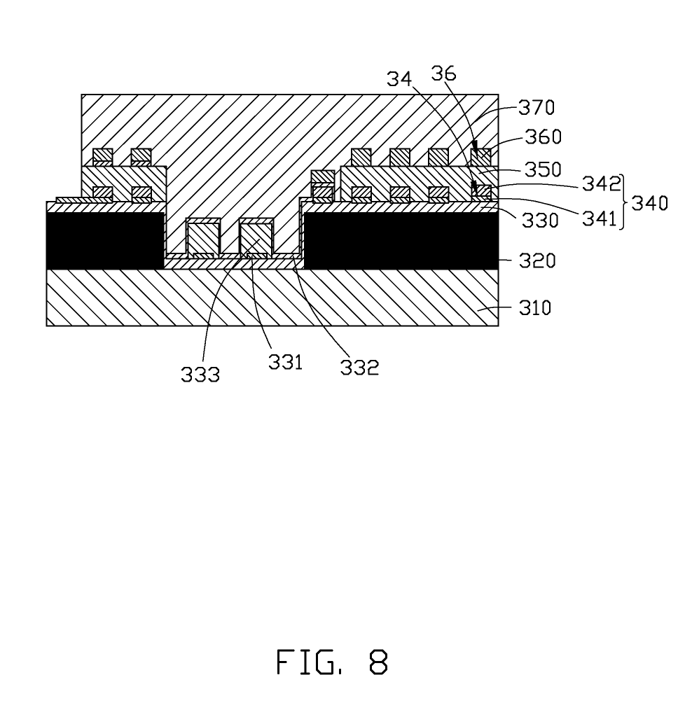

Referring to FIG. 8, FIG. 8 is a cross-sectional view of the touch module of FIG. 3 taken along line VI-VI according to a second embodiment. In the second embodiment, the touch module 20 includes a substrate 310. The substrate 310 can be a glass substrate, a transparent resin substrate, or a transparent thin film substrate. A shielding layer 320 is coated on a surface of the substrate 310. The shielding layer 320 is located at a position on the surface of the substrate 310 corresponding to the trace area 22.

The touch module 20 further includes a first insulation layer 330 covering the substrate 310 and the shielding layer 320. In this embodiment, the first insulation layer 330 is divided into a first region corresponding to the touch area 21, and a second region corresponding to the trace area 22. A plurality of first sensor electrodes 331 and a plurality of second sensor electrodes 332 are arranged in the first region of the first insulation layer 330. The first sensor electrodes 331 and the second sensor electrodes 332 are made of conductive materials. In at least one embodiment, the first sensor electrodes 331 and the second sensor electrodes 332 are made of transparent conductive materials, such as indium tin oxide (ITO). The first sensor electrodes 331 are insulated from the second sensor electrodes 332 via a first protection layer 333. The first protection layer 333 can be made of insulating materials such as resin materials or photo resist materials.

A first trace layer 34 is formed in the second region of the first insulation layer 330 corresponding to the trace area 22 of the touch module 20. The first trace layer 34 includes a plurality of first conductive traces 340 coupled to the first sensor electrodes 331 or the second sensor electrodes 332. In at least one embodiment, at least one first conductive trace 340 includes a first conductive layer 341 and a second conductive layer 342 covering the first conductive layer 341. The first conductive layer 341 and the second conductive layer 342 can be made of the same conductive materials or different conductive materials.

In at least one embodiment, each of the first conductive traces 340 includes the first conductive layer 341 and the second conductive layer 342, and the first conductive layer 341 and the second conductive layer 342 are made of different conductive materials. In at least one embodiment, the first conductive traces 340 are coupled to the first sensor electrodes 331, and the first conductive layer 341 and the first sensor electrodes 331 are made of the same materials in a same mask etching process. The second conductive layer 342 is made of metal materials or alloy materials and electrically coupled with the first conductive layer 341.

A second insulation layer 350 is formed above the first trace layer 34. The second insulation layer 350 can be made of the same materials as the first protection layer 333 in a same manufacturing process. A second trace layer 36 is formed on the second insulation layer 350. The second trace layer 36 includes a plurality of second conductive traces 360. The second conductive traces 360 only include a single conductive layer. In addition, a second protection layer 370 is coated on the second trace layer 36 and covers the second conductive traces 360. The second protection layer 370 can be made of organic materials or inorganic materials.

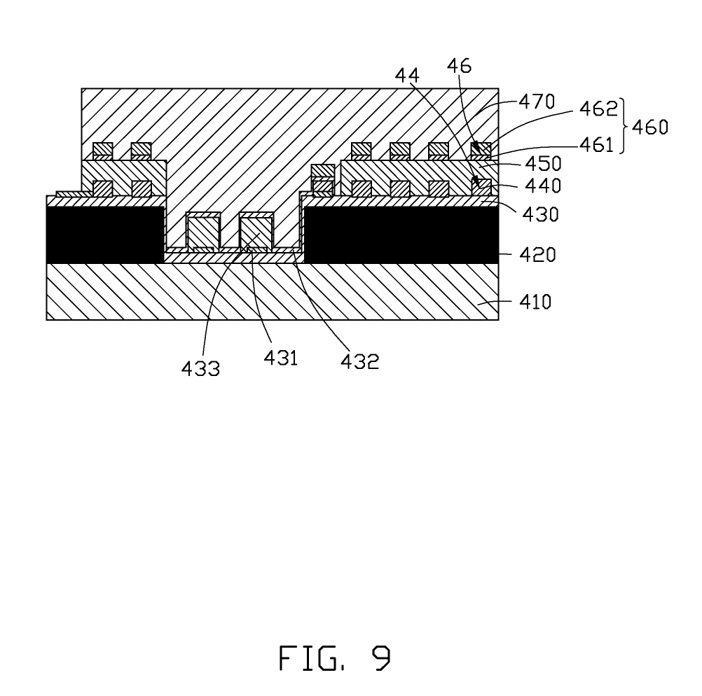

Referring to FIG. 9, FIG. 9 is a cross-sectional view of the touch module of FIG. 3 taken along line VI-VI according to a third embodiment. In the third embodiment, the touch module 20 includes a substrate 410. The substrate 410 can be a glass substrate, a transparent resin substrate, or a transparent thin film substrate. A shielding layer 420 is coated on a surface of the substrate 410. The shielding layer 420 is located at a position on the surface of the substrate 410 corresponding to the trace area 22.

The touch module 20 further includes a first insulation layer 430 covering the substrate 410 and the shielding layer 420. In this embodiment, the first insulation layer 430 is divided into a first region corresponding to the touch area 21 and a second region corresponding to the trace area 22. A plurality of first sensor electrodes 431 and a plurality of second sensor electrodes 432 are arranged in the first region of the first insulation layer 430. The first sensor electrodes 431 and the second sensor electrodes 432 are made of conductive materials. In at least one embodiment, the first sensor electrodes 431 and the second sensor electrodes 432 are made of transparent conductive materials, such as indium tin oxide (ITO). The first sensor electrodes 431 are insulated from the second sensor electrodes 432 via a first protection layer 433. The first protection layer 433 can be made of insulating materials such as resin materials or photo resist materials.

A first trace layer 44 is defined in the second region of the first insulation layer 430 corresponding to the trace area 22 of the touch module 20. The first trace layer 44 includes a plurality of first conductive traces 440 coupled to the first sensor electrodes 431 or the second sensor electrodes 432. The first conductive traces 440 only include single conductive layer.

A second insulation layer 450 is formed on the first trace layer 44. The second insulation layer 450 can be made of the same materials with the first protection layer 433 in a same manufacturing process. A second trace layer 46 is formed on the second insulation layer 450. The second trace layer 46 includes a plurality of second conductive traces 460. In at least one embodiment, at least one second conductive trace 460 includes two conductive layers, for example a first conductive layer 461 and a second conductive layer 462 covering the first conductive layer 461. The first conductive layer 461 and the second conductive layer 462 can be made of the same conductive materials or different conductive materials.

In at least one embodiment, each of the second conductive traces 260 includes the first conductive layer 461 and the second conductive layer 462, and the first conductive layer 461 and the second conductive layer 462 are made of different conductive materials. In at least one embodiment, the second conductive trace 460 is coupled to the second sensor electrode 432, and the first conductive layer 461 and the second electrode 432 are made of the same materials in a same mask etching process. The second conductive layer 462 is made of metal materials or alloy materials and electrically coupled with the first conductive layer 461. In addition, a second protection layer 470 is defined on the second trace layer 46 and covers the second conductive traces 460. The second protection layer 470 can be made of organic materials or inorganic materials.

As described above, the fan-out traces of the touch module 20 are located at two different trace layers. Thus, the border width of the touch module 20 can be 50% smaller than the border width of the traditional touch module having a single trace layer, thereby allowing the touch module 20 to have a narrower border.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A touch module of a touch device, comprising:
a touch area and a trace area surrounding the touch area;
a substrate;
a plurality of first sensor electrodes and a plurality of second sensor electrodes arranged in a first region on the substrate corresponding to the touch area; and
a plurality of conductive traces arranged in a second region on the substrate corresponding to the trace area, wherein at least one of the conductive traces comprises at least two conductive layers.

2. The touch module according to claim 1, wherein the plurality of conductive traces comprise a plurality of first conductive traces arranged on a first trace layer and a plurality of second conductive traces arranged on a second trace layer, the second trace layer is located above the first trace layer.

3. The touch module according to claim 2, wherein the first conductive trace comprises a first conductive layer and a second conductive layer covering the first conductive layer, and the second conductive trace comprises a third conductive layer and a fourth conductive layer covering the third conductive layer.

4. The touch module according to claim 3, wherein the first conductive layer and the first sensor electrode are made of the same materials in a same mask etching process.

5. The touch module according to claim 3, wherein the third conductive layer and the second electrode are made of the same materials in a same mask etching process.

6. The touch module according to claim 2, wherein the first conductive trace comprises a first conductive layer and a second conductive layer covering the first conductive layer, and the second conductive trace comprises a single conductive layer.

7. The touch module according to claim 6, wherein the first conductive layer and the first sensor electrode are made of the same materials in a same mask etching process.

8. The touch module according to claim 2, wherein the first conductive trace comprises a single conductive layer, and the second conductive layer comprises a first conductive layer and a second conductive layer covering the first conductive layer.

9. The touch module according to claim 8, wherein the first conductive layer and the second sensor electrode are made of the same materials in a same mask etching process.

10. The touch module according to claim 2, wherein the second conductive trace projected on the first trace layer overlaps with the first conductive trace.

11. The touch module according to claim 2, wherein the second conductive trace projected on the first trace layer is located between two adjacent first conductive traces.

12. A touch device, comprising:
a touch module, and a display module, the touch module being positioned above the display module, the touch module comprising:
a touch area and a trace area surrounding the touch area;
a substrate;
a plurality of first sensor electrodes and a plurality of second sensor electrodes arranged in a first region on the substrate corresponding to the touch area; and
a plurality of conductive traces arranged in a second region on the substrate corresponding to the trace area, wherein at least one of the conductive traces comprising at least two conductive layers.

13. The touch device according to claim 12, wherein the plurality of conductive traces comprise a plurality of first conductive traces arranged on a first trace layer and a plurality of second conductive traces arranged on a second trace layer, the second trace layer is located above the first trace layer.

14. The touch device according to claim 13, wherein the first conductive trace comprises a first conductive layer and a second conductive layer covering the first conductive layer, and the second conductive trace comprises a third conductive layer and a fourth conductive layer covering the third conductive layer.

15. The touch device according to claim 14, wherein the first conductive layer and the first sensor electrode are made of the same materials in a same mask etching process.

16. The touch device according to claim 14, wherein the third conductive layer and the second electrode are made of the same materials in a same mask etching process.

17. The touch device according to claim 13, wherein the first conductive trace comprises a first conductive layer and a second conductive layer covering the first conductive layer, and the second conductive trace comprises a single conductive layer.

18. The touch device according to claim 13, wherein the first conductive trace comprises a single conductive layer, and the second conductive layer comprises a first conductive layer and a second conductive layer covering the first conductive layer.

19. The touch device according to claim 13, wherein the second conductive trace projected on the first trace layer overlaps with the first conductive trace.

20. The touch device according to claim 13, wherein the second conductive trace projected on the first trace layer is between two adjacent first conductive traces.
